(19) United States
(12) Patent Application Publication
(10) Pub. No.: US 2022/0341724 A1
(43) Pub. Date: Oct. 27, 2022

(54) PARALLEL OPTICAL SCANNING INSPECTION DEVICE

(71) Applicant: Opxion Technology Incorporation, New Taipei (TW)

(72) Inventors: WEN-JU CHEN, New Taipei (TW); FENG-YU CHANG, New Taipei (TW); YI-TING LIN, New Taipei (TW)

(21) Appl. No.: 17/521,003

(22) Filed: Nov. 8, 2021

(30) Foreign Application Priority Data
Apr. 21, 2021 (TW) 110114379

(51) Int. Cl. G01B 9/02; G01N 21/45

(52) U.S. Cl. CPC G01B 9/02091; G01N 21/45; G01B 9/02027

(57) ABSTRACT

A parallel optical scanning inspection device, comprising a light source unit, an interference unit, a beam splitting unit, an optical path adjustment unit, a plurality of scanning units and a receiving unit. The light source unit provides initial light to an interference unit. The interference unit divides the initial light into reference light and sampling light. The beam splitting unit splits the sampling light into a plurality of sampling light beams. The optical path adjustment unit adjusts the plurality of sampling light beams into scanning light beams with different optical paths. Each of the scanning units receives one of the scanning light beams. A sample is scanned by the scanning light beams such that each of the scanning units receives detection light reflected or scattered from different positions of the sample. The receiving unit receives and coheres the reference light and the detection light, respectively, to generate optical information.

### REFERENCE TO RELATED APPLICATIONS

The present application is based on, and claims priority from, Taiwan application number 110114379 filed Apr. 21, 2021, the disclosure of which is hereby incorporated by reference herein in its entirety.

### BACKGROUND OF THE INVENTION

### Field of the Invention

The present invention generally relates to a detection device and, more particularly, to a parallel optical scanning inspection device capable of performing optical detection on a sample using multiple channels with different optical paths at the same time to produce, based on coherence effect with different optical path differences, optical information, which is processed and analyzed by a computer to obtain optical coherence tomography images of the sample.

### Description of the Prior Art

According to Wikipedia, “interferometry” is a technology that obtains information through interference caused by the superposition of waves (generally, electromagnetic waves). Such technology is very important for the research in the fields comprising astronomy, optical fiber, engineering metrology, optical metrology, oceanography, seismology, spectroscopy and its applications in chemistry, quantum mechanics, nuclear physics, particle physics, plasma physics, remote sensing, interaction between biological molecules, surface profile analysis, microfluidics, research of stress and strain measurement, velocimetry and optometry.

For Michelson interferometry, after light is incident on a beam splitter at an angle of 45°, it is divided into two mutually perpendicular beams, which are respectively directed to two total reflection mirrors and are reflected back to the beam splitter and are superimposed on the screen through the beam splitter again to produce interference beam fringes. For Mach-Zehnder interferometry, it can be observed that the relative phase shift changes due to different paths and the medium after the beam emitted from a single light source is split into two collimated beams. The depth signals of different paths but the same optical path can be adjusted to interfere, which can be used for detection of depth information of objects.

However, the conventional interferometry uses only one scanning lens facing the sample to be detected, which limits the inspection speed and leads to low detection efficiency. Such problem needs to be overcome.

### SUMMARY OF THE INVENTION

In view of the foregoing problems of the prior art, one object of the present invention is to scan different positions of the same sample and produce optical information of the coherence effect with different optical path differences at the same time without changing too much structural composition of the interferometry. The optical information of the coherent effect is processed and analyzed by the computer to synchronously obtain the optical coherent tomography images of different positions of the sample.

To achieve the foregoing object, the present invention provides a parallel optical scanning inspection device, comprising a light source unit, an interference unit, a beam splitting unit, an optical path adjustment unit, a plurality of scanning units and a receiving unit. The light source unit provides initial light to an interference unit. The interference unit divides the initial light into reference light and sampling light. The beam splitting unit splits the sampling light into a plurality of sampling light beams. The optical path adjustment unit adjusts the plurality of sampling light beams into scanning light beams with different optical paths. Each of the scanning units receives one of the scanning light beams, wherein a sample is scanned by the scanning light beams at different positions such that each of the scanning units receives detection light reflected from the different positions of the sample. The receiving unit receives and coheres the reference light and the detection light, respectively, to generate optical information based on coherence effect with different optical path differences. Each optical information is processed and analyzed by a computer to obtain optical coherence tomography images of different positions of the sample.

More particularly, the light source unit includes a swept source laser, an optical amplifier and an optical isolator. The swept source laser and the optical amplifier is connected by an optical fiber. The optical isolator is disposed between the swept source laser and the optical amplifier. The optical amplifier amplifies the laser beam to the initial light with light intensity suitable for optical coherent tomography. The optical isolator prevents the initial light from hitting back and causing damage to the swept source laser.

More particularly, the interference unit includes a first fiber coupler, a second fiber coupler, a first fiber circulator, a second fiber circulator, a first fiber polarization controller, a second fiber polarization controller, and a reference light generator. One end of the first fiber coupler is connected to the optical amplifier. The other end of the first fiber coupler is connected to a first end of the first fiber circulator and a first end of the second fiber circulator. A second end of the first fiber circulator is connected to one end of the first fiber polarization controller. The other end of the first fiber polarization controller is connected to the reference light generator. A second end of the second fiber circulator is connected to one end of the second fiber polarization controller. The other end of the second fiber polarization controller is connected to the beam splitting unit. A third end of the first fiber circulator and a third end of the second fiber circulator are connected to one end of the second fiber coupler. The other end of the second fiber coupler is connected to the receiving unit. Accordingly, the initial light enters the reference light generator after passing through the first fiber coupler, the first end of the first fiber circulator, the second end of the first fiber circulator, and the first fiber polarization controller to generate the reference light, and then the reference light enters the receiving unit after passing through the first fiber polarization controller, the second end and the third end of the first fiber circulator, and the second fiber coupler in order. The initial light functions as the sampling light after passing through the first fiber coupler, the first end and the second end of the second fiber circulator, and the second fiber polarization controller.

More particularly, the beam splitting unit includes a plurality of third fiber couplers connected to each other in a one-to-two tree-like branch, wherein one end of one of the third fiber couplers of a first layer is connected to the interference unit, and the other ends of the third fiber couplers of a last layer are connected to the optical path adjustment unit.

More particularly, each of the scanning units includes a scanning light beam collimator, a scanning reflector, an optical scanning element and a scanning lens. The scanning light beam collimator receives one of the scanning light beams. When the scanning light beam enters the optical scanning element after passing through the scanning reflector, the optical scanning element controls the scanning light beam to perform one-dimensional or multi-dimensional scanning on the sample, and then the one-dimensional or multi-dimensional detection light reflected by the sample is sequentially scanned by the scanning lens, the optical scanning element, the scanning reflector, the scanning light beam collimator, the optical path adjustment unit, the beam splitting unit, the interference unit and the receiving unit, such that the receiving unit can receive the detection light.

More particularly, the optical path adjustment unit includes a plurality of fiber jumpers with different optical paths, such that a position of a scanning light beam collimator capable of freely adjusting the position is adjusted to match the fiber jumpers with different optical paths to form the scanning light beams as the sampling light passes through the different optical paths. Alternatively, the optical path adjustment unit includes a plurality of adjustment portions. Each of the adjustment portions includes a first graded refractive index beam collimator and a second graded refractive index beam collimator. One end of the first graded refractive index beam collimator is connected to the beam splitting unit. The other end of the second graded refractive index beam collimator is connected to the scanning units. The other end of the first graded refractive index beam collimator and one end of the second graded refractive index beam collimator are movably connected to adjust the position of the other end of the first graded refractive index beam collimator relative to the one end of the second graded refractive index beam collimator to form the scanning light beams as the sampling light passes through the different optical paths.

More particularly, the reference light generator includes a reference light beam collimator, a reference lens, and a reference reflector. One end of the reference light beam collimator is connected to the other end of the first fiber polarization controller. The other end of the reference light beam collimator faces the reference lens. The reference lens faces the reference reflector, such that the initial light enters the reference light beam collimator and the reference lens to reach the reference reflector, and is then reflected by the reference reflector to become the reference light.

More particularly, the reference reflector is disposed on a first moving unit, and the first moving unit is adjusted to move the reference reflector to change the path of the initial light in free space. In other words, the optical path difference between the reference light and each scanning light beam is adjusted to obtain the best imaging depth range of each scanning beam to the sample.

More particularly, each of the scanning units is disposed on a second moving unit, and the second moving unit is adjusted to move each of the scanning units horizontally or vertically to adjust the focal length of each of the scanning units.

In summary, in the present invention scanning light beams with different optical paths is produced through a beam splitting unit, an optical path adjustment unit and scanning units. Furthermore, in the present invention detection light is received, and the optical coherence effect is performed with the reference light and the detection light separately, so that a receiving unit produces optical information of the coherence effect with different optical path differences. Each optical information is processed and analyzed by a computer to obtain optical coherence tomography images of different positions of the sample. Such multi-channel parallel synchronous detection of samples significantly improves the detection efficiency.

### BRIEF DESCRIPTION OF THE DRAWINGS

In order to make the above and other objects, features, advantages, and embodiments of the present disclosure easier to understand, the description of the accompanying drawings is as follows:

FIG. 1 is a schematic diagram of a parallel optical scanning inspection device according to one embodiment of the present invention;

FIG. 2 is a schematic diagram of a parallel optical scanning inspection device according to another embodiment of the present invention;

FIG. 3 is an optical coherent tomography image of a single position using conventional interferometry; and

FIG. 4 is a synchronous optical coherent tomography image of different positions by parallel scanning according to the present invention.

### DESCRIPTION OF THE PREFERRED EMBODIMENTS

In order to provide a better understanding of the features and the objects of the present invention, the following embodiments and accompanying descriptions are presented herein.

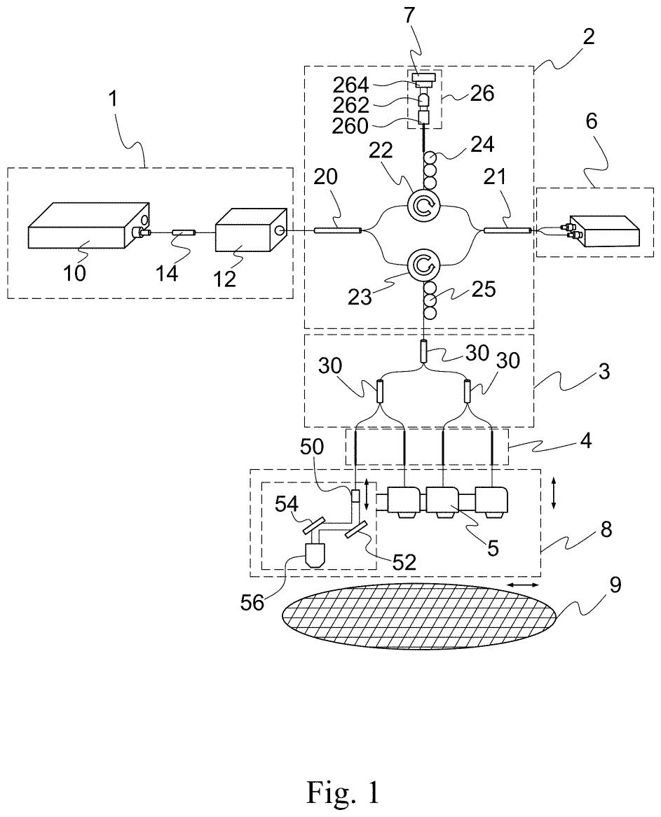

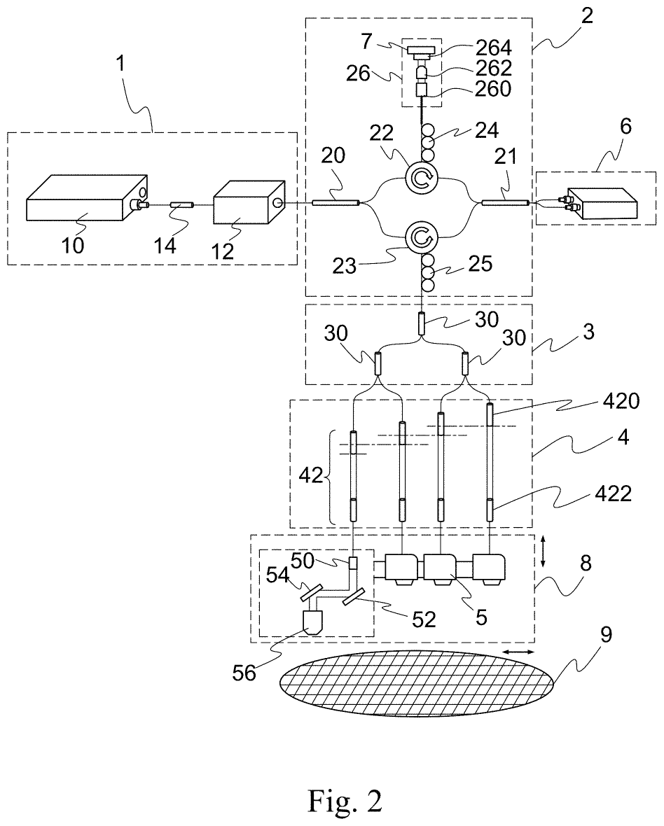

Referring to FIGS. 1 and 2, the present invention relates to a parallel optical scanning inspection device, which includes a light source unit 1, an interference unit 2, a beam splitting unit 3, an optical path adjustment unit 4, a plurality of scanning units 5 and a receiving units 6. The interference unit 2 receives initial light provided by the light source unit 1 and divides the initial light into reference light and sampling light. The optical path adjustment unit 4 adjusts the plurality of sampling light beams into scanning light beams with different optical paths. Each of the scanning units 5 receives one of the scanning light beams, wherein a sample 9 is scanned by the scanning light beams at different positions such that each of the scanning units 5 receives detection light reflected from the different positions of the sample 9. The receiving unit 6 receives and coheres the reference light and the detection light, respectively, to generate optical information based on coherence effect with different optical path differences. Each optical information is processed and analyzed by a computer to obtain optical coherence tomography images of different positions of the sample 9. The sample 9 can be a wafer, a thin film, a conductive glass, a solar cell panel, a laser diode, a light-emitting diode, a material, a semiconductor component, etc., but the present invention is not limited thereto when it is actually implemented. Anything that has the surface to be detected is the sample 9 that the present invention refers to.

In the present invention, referring to FIG. 1, the light source unit 1 includes a swept source laser 10, an optical amplifier 12 and an optical isolator 14. The swept source laser 10 and the optical amplifier 12 is connected by an optical fiber. The optical isolator 14 is a fiber disposed between the swept source laser 10 and the optical amplifier 12. The optical amplifier 12 amplifies the laser beam to the initial light with light intensity suitable for optical coherent tomography. The optical isolator 14 prevents the initial light from hitting back and causing damage to the swept source laser 10. The present invention is not limited thereto, all light that can interfere with low-coherence light belong to the initial light that the present invention refers to.

In the present invention, the interference unit 2 includes a first fiber coupler 20, a second fiber coupler 21, a first fiber circulator 22, a second fiber circulator 23, a first fiber polarization controller 24, a second fiber polarization controller 25, and a reference light generator 26. One end of the first fiber coupler 20 is connected to the light source unit 1 (i.e., the other end of the optical amplifier 12). The other end of the first fiber coupler 20 is connected to the first fiber circulator 22. A second end of the first fiber circulator 22 is connected to one end of the first fiber polarization controller 24. The other end of the first fiber polarization controller 24 is connected to the reference light generator 26. A third end of the first fiber circulator 22 is connected to one end of the second fiber coupler 21. The other end of the second fiber coupler 21 is connected to the receiving unit 6. Accordingly, the initial light enters the reference light generator 26 after passing through the first fiber coupler 20, the first end of the first fiber circulator 22, the second end of the first fiber circulator 22, and the first fiber polarization controller 24 to generate the reference light, and then the reference light enters the receiving unit 6 after passing through the first fiber polarization controller 24, the second end and the third end of the first fiber circulator 22, and the second fiber coupler 21 in order.

In addition, the first end of the second fiber circulator 23 is also connected to one end of the first fiber coupler 20. The second end of the second fiber circulator 23 is connected to one end of the second fiber polarization controller 25. The other end of the second fiber polarization controller 25 is connected to the beam splitting unit 3. The third end of the second fiber circulator 23 is connected to one end of the second fiber coupler 21. Accordingly, the initial light functions as the sampling light after passing through the first fiber coupler 20, the first end and the second end of the second fiber circulator 23, and the second fiber polarization controller 25.

In the present invention, the reference light generator 26 includes a reference light beam collimator 260, a reference lens 262, and a reference reflector 264. One end of the reference light beam collimator 260 is connected to the other end of the first fiber polarization controller 24. The other end of the reference light beam collimator 260 faces the reference lens 262. The reference lens 262 faces the reference reflector 264, such that the initial light enters the reference light beam collimator 260 and the reference lens 262 to reach the reference reflector 264, and is then reflected by the reference reflector 264 to become the reference light.

In the present invention, the reference reflector 264 is disposed on a first moving unit 7, and the first moving unit 7 is adjusted to move the reference reflector 264 to change the path of the initial light in free space. The optical path difference between the reference light and each scanning light beam is adjusted to obtain the best imaging depth range of each scanning beam to the sample 9. Also, each of the scanning units 5 is disposed on a second moving unit 8, and the second moving unit 8 is adjusted to move each of the scanning units horizontally or vertically to adjust the focal length of each of the scanning units 5. In FIG. 1 and FIG. 2 of the present invention, up and down arrow symbols are drawn next to the number 8 to indicate that the second moving unit 8 can be adjusted freely, and it is not limited to only moving up and down.

In the present invention, the beam splitting unit 3 includes a plurality of third fiber couplers 30 connected to each other in a one-to-two tree-like branch, wherein one end of one of the third fiber couplers 30 of a first layer is connected to the interference unit 2 (the other end of the second fiber polarization controller 25 of the interference unit 2), and the other ends of the third fiber couplers 30 of a last layer are connected to the optical path adjustment unit 4, which is connected to the scanning unit 50.

In the present invention, each of the scanning units 5 includes a scanning light beam collimator 50, a scanning reflector 52, an optical scanning element 54 and a scanning lens 56. The scanning light beam collimator 50 receives one of the scanning light beams. When the scanning light beam enters the optical scanning element 54 after passing through the scanning reflector 52, the optical scanning element 54 controls the scanning light beam to perform one-dimensional or multi-dimensional scanning on the sample 9, and then the one-dimensional or multi-dimensional detection light reflected by the sample 9 is sequentially scanned by the scanning lens 56, the optical scanning element 54, the scanning reflector 52, the scanning light beam collimator 50, the optical path adjustment unit 4, the beam splitting unit 3, the interference unit 2 and the receiving unit 6, such that the receiving unit 6 can receive the detection light. More particularly, the optical scanning element 54 controls the rotation angle and the rotation speed of the scanning light beam on the X-axis and Y-axis through external voltage such that the angle of the scanning light beam after being reflected by the optical scanning element 54 can be changed so as to perform one-dimensional or multi-dimensional scanning.

In one embodiment of the present invention, referring to FIG. 1, the optical path adjustment unit 4 includes a plurality of fiber jumpers 40 with different optical paths and the position of the scanning light beam collimator 50 is matched with the fiber jumpers 40 different optical paths, such that the sampling light goes through different light paths to form each scanning light beam. Furthermore, the fiber jumpers 40 roughly changes the optical path by the length of the fiber, and further adjusts the position of the scanning light beam collimator 50 to precisely adjust the required optical path. In FIG. 1, the up and down arrow symbols are drawn next to the number 50 to indicate that the scanning light beam collimator 50 can be adjusted freely, instead of being limited to only moving up and down.

In another embodiment of the present invention, referring to FIG. 2, the optical path adjustment unit 4 includes a plurality of adjustment portions 42. Each of the adjustment portions 42 includes a first graded refractive index beam collimator 420 and a second graded refractive index beam collimator 422. One end of the first graded refractive index beam collimator 420 is connected to the beam splitting unit 3. The other end of the second graded refractive index beam collimator 422 is connected to the scanning units 5. The other end of the first graded refractive index beam collimator 420 and one end of the second graded refractive index beam collimator 422 are movably connected to adjust the position of the other end of the first graded refractive index beam collimator 420 relative to the one end of the second graded refractive index beam collimator 422 to form the scanning light beams as the sampling light passes through the different optical paths.

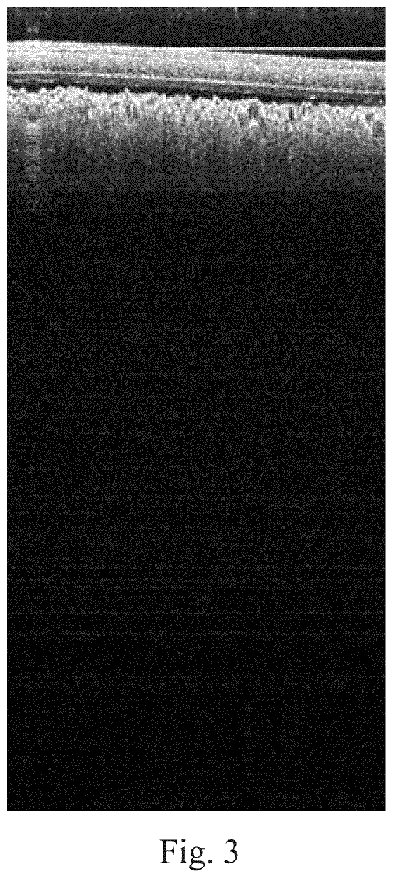

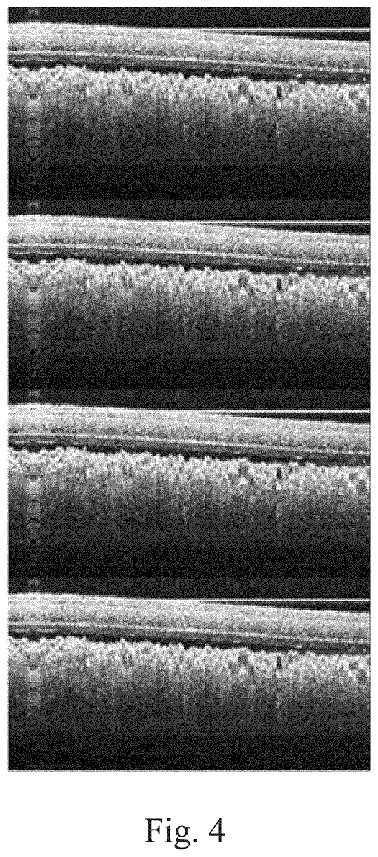

In summary, the conventional interferometry uses only one coherent effect optical information, and processes and analyzes the optical information by a computer to synchronously obtain optical coherent tomography image of a single position of the sample 9 (as shown in FIG. 3). In contrast, in the present invention, the beam splitting unit 3 splits the sampling light into a plurality of sampling light beams, and then the sampling lights are adjusted by the optical path adjustment unit 4 and the scanning units 50 with different optical paths to provide scanning light beams with different optical paths. Each of the scanning units 5 uses a scanning light beam to detect a different portion of the sample 9, and receives each detection light reflected by sample 9. The scanning units 5 transmits the detection light to the receiving unit 6, such that the receiving unit 6 receives the reference light and the detection light to perform the optical coherent effect to produce optical information of the coherence effect with different optical path differences. The optical information is processed and analyzed by a computer to obtain optical coherence tomography images of different positions of the sample 9 (as shown in FIG. 4). Such multi-channel parallel synchronous detection of samples significantly improves the detection efficiency.

The above content is merely illustrative of the present invention. Although various embodiments of the present invention have been described to a certain degree of characteristics, with reference to one or more embodiments, those with ordinary skill in the art to which the present invention belongs can still make numerous modifications to the disclosed implementations without departing from the spirit and scope of the present invention.

What is claimed is:

1. A parallel optical scanning inspection device, comprising:
a light source unit, configured to provide initial light;
an interference unit, connected to the light source unit and configured to receive the initial light and divide the initial light into reference light and sampling light;
a beam splitting unit, connected to the interference unit and configured to split the sampling light into a plurality of sampling light beams;
an optical path adjustment unit, connected to the beam splitting unit and configured to adjust the plurality of sampling light beams into scanning light beams with different optical paths;
a plurality of scanning units, each connected to the optical path adjustment unit and configured to receive one of the scanning light beams, wherein a sample is scanned by the scanning light beams at different positions such that each of the scanning units receives detection light reflected from the different positions of the sample such that the detection light enters the interference unit after passing through the optical path adjustment unit and the beam splitting unit; and
a receiving unit, connected to the interference unit and configured to receive and cohere the reference light and the detection light, respectively, to generate optical information based on coherence effect with different optical path differences.

2. The parallel optical scanning inspection device according to claim 1, wherein the light source unit comprises:
a swept source laser, configured to provide a laser beam; and
an optical amplifier, connected to the swept source laser and configured to amplify the laser beam to the initial light with light intensity suitable for optical coherent tomography.

3. The parallel optical scanning inspection device according to claim 2, wherein the light source unit further comprises an optical isolator disposed between the swept source laser and the optical amplifier.

4. The parallel optical scanning inspection device according to claim 1, wherein the interference unit comprises:
a first fiber coupler, having one end connected to the light source unit;
a first fiber circulator, having a first end connected to the other end of the first fiber coupler;
a first fiber polarization controller, having one end connected to a second end of the first fiber circulator;
a reference light generator, connected to the other end of the first fiber polarization controller;
a second fiber circulator, having a first end connected to the other end of the first fiber coupler;
a second fiber polarization controller, having one end connected to a second end of the second fiber circulator and having the other end connected to the beam splitting unit; and
a second fiber coupler, having one end connected to a third end of the first fiber circulator and a third end of the second fiber circulator and having the other end connected to the receiving unit,
wherein the initial light enters the reference light generator after passing through the first fiber coupler, the first end of the first fiber circulator, the second end of the first fiber circulator, and the first fiber polarization controller to generate the reference light, and then the reference light enters the receiving unit after passing through the first fiber polarization controller, the second end and the third end of the first fiber circulator, and the second fiber coupler in order;
wherein, the initial light functions as the sampling light after passing through the first fiber coupler, the first end and the second end of the second fiber circulator, and the second fiber polarization controller.

5. The parallel optical scanning inspection device according to claim 4, wherein the reference light generator comprises:
a reference light beam collimator, having one end connected to the other end of the first fiber polarization controller;
a reference lens, having one surface facing the other end of the reference light beam collimator; and
a reference reflector, facing the other surface of the reference lens;
wherein the initial light enters the reference light beam collimator and the reference lens to reach the reference reflector, and is then reflected by the reference reflector to become the reference light.

6. The parallel optical scanning inspection device according to claim 4, wherein the interference unit further comprises a first moving unit, the reference reflector is disposed on the first moving unit, and the first moving unit is adjusted to move the reference reflector to change the path of the initial light in free space.

7. The parallel optical scanning inspection device according to claim 1, wherein the beam splitting unit comprises a plurality of third fiber couplers, the plurality of third fiber couplers are connected in a one-to-two tree-like branch, wherein one end of one of the third fiber couplers of a first layer is connected to the interference unit, and the other ends of the third fiber couplers of a last layer are connected to the optical path adjustment unit.

8. The parallel optical scanning inspection device according to claim 1, wherein each of the scanning units comprises:
a scanning light beam collimator, configured to receive one of the scanning light beams;
a scanning reflector, configured to receive the one of the scanning light beams from the scanning light beam collimator;
an optical scanning element, configured to receive the one of the scanning light beams from the scanning reflector; and
a scanning lens, configured to receive the one of the scanning light beams from the optical scanning element;
wherein the optical scanning element controls the scanning light beam to perform one-dimensional or multi-dimensional scanning on the sample, and then the one-dimensional or multi-dimensional detection light reflected by the sample is transmitted and received sequentially by the scanning lens, the optical scanning element, the scanning reflector, the scanning light beam collimator, the optical path adjustment unit, the beam splitting unit, the interference unit and the receiving unit.

9. The parallel optical scanning inspection device according to claim 6, wherein the optical path adjustment unit comprises a plurality of fiber jumpers with different optical paths, such that a position of a scanning light beam collimator capable of freely adjusting the position is adjusted to match the fiber jumpers with different optical paths to form the scanning light beams as the sampling light passes through the different optical paths.

10. The parallel optical scanning inspection device according to claim 1, wherein the optical path adjustment unit comprises a plurality of adjustment portions, each comprising:
a first graded refractive index beam collimator, having one end connected to the beam splitting unit; and
a second graded refractive index beam collimator, having one end being mutually movable with the other end of the first graded refractive index beam collimator to adjust the position of the other end of the first graded refractive index beam collimator relative to the one end of the second graded refractive index beam collimator, such that the other end of the second graded refractive index beam collimator is connected to the scanning units to form the scanning light beams as the sampling light passes through the different optical paths.

11. The parallel optical scanning inspection device according to claim 1, wherein each of the scanning units is disposed on a second moving unit, and the second moving unit is adjusted to move each of the scanning units horizontally or vertically to adjust the focal length of each of the scanning unit
